(19) United States
(12) Patent Application Publication
(10) Pub. No.: US 2025/0021513 A1
(43) Pub. Date: Jan. 16, 2025

(54) SYNCHRONIZATION SIGNAL TRANSMISSION METHOD AND SERIAL COMMUNICATION SYSTEM

(71) Applicant: Silergy Semiconductor Technology (Hangzhou) LTD, Hangzhou (CN)

(72) Inventors: Yuanyu Yang, Hangzhou (CN); Jianxin Wang, Hangzhou (CN); Xiaoqiang Xu, Hangzhou (CN)

(21) Appl. No.: 18/764,890

(22) Filed: Jul. 5, 2024

(30) Foreign Application Priority Data
Jul. 12, 2023 (CN) 202310855014.0

(51) Int. Cl. G06F 13/42

(52) U.S. Cl. CPC G06F 13/4282

(57) ABSTRACT

A method of synchronization signal transmission for a serial communication system having a master device and a plurality of slave devices coupled in series, can include: controlling the plurality of slave devices to be in a through state, in order to form a linked pathway when a synchronization signal needs to be transmitted; and transmitting the synchronization signal to the linked pathway, such that the plurality of slave devices receive the synchronization signal at the same time.

### RELATED APPLICATIONS

This application claims the benefit of Chinese Patent Application No. 202310855014.0, filed on Jul. 12, 2023, which is incorporated herein by reference in its entirety.

### FIELD OF THE INVENTION

The present invention generally relates to the field of communications, and more particularly, to synchronization signal transmission methods and serial communication systems.

### BACKGROUND

Referring now to FIG. 1, shown is a schematic diagram of an example backlight system. In this particular example, the backlight system can include a master device and slave devices IC1-ICn coupled in series. Each slave device can include power supply port Vcc that may receive power supply voltage signal VIN, ground potential port GND that can be coupled to the ground potential, and synchronization port VSYNC that may receive synchronization signal VSYNC sent by the master device.

### BRIEF DESCRIPTION OF THE DRAWINGS

FIG. 1 is a schematic diagram of an example backlight system.

FIG. 2 is a schematic diagram of a first example serial communication system, in accordance with embodiments of the present invention.

FIG. 3 is a waveform diagram of an example specific instruction and an example synchronization signal, in accordance with embodiments of the present invention.

FIG. 4 is a schematic diagram of a second example serial communication system, in accordance with embodiments of the present invention.

FIG. 5 is a schematic diagram of a third example serial communication system, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

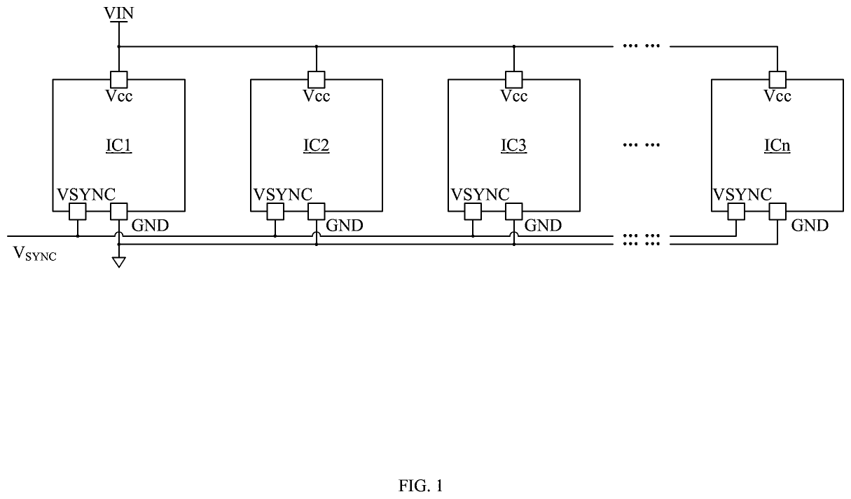

It is desirable to realize all of the wiring of the slave devices in the example backlight system of FIG. 1 on a single-layer aluminum substrate, in order to reduce the cost. However, after the wiring of the power supply port and the ground potential port is completed on the single-layer aluminum substrate, the synchronization port may not be wired on the same layer, and can be blocked by the wiring of the power supply port and the ground potential port. As a result, it may not be possible to realize all wiring of the slave devices in the backlight system in this example with the single-layer aluminum substrate. In order to solve such problems, jumpers or double-layer wiring may typically be utilized, which can greatly increase the cost.

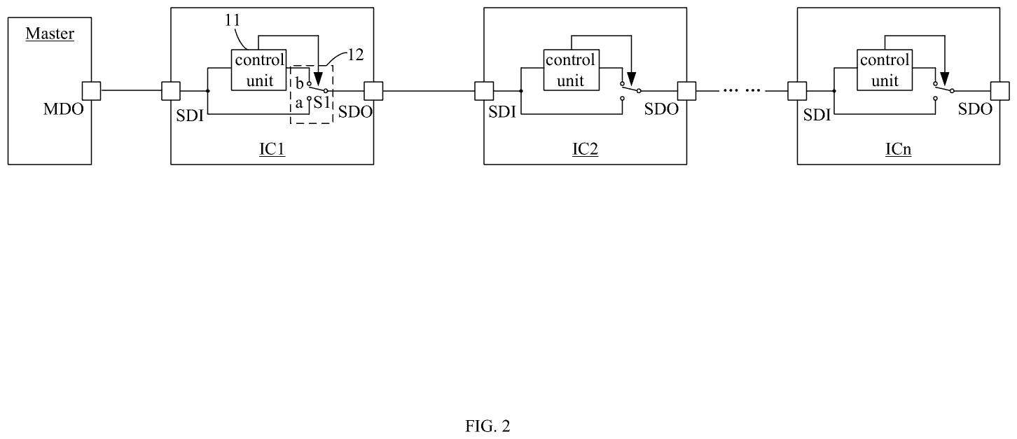

Referring now to FIG. 2, shown is a schematic diagram of an example serial communication system, in accordance with embodiments of the present invention. In this particular example, the serial communication system can include a master device and n slave devices IC1-ICn coupled in series in sequence, where n is a positive integer. For example, each slave device can include input port SDI and output port SDO. Input port SDI of slave device IC1 can connect to output port MDO of the master device, and input ports SDI of slave device IC2 to nth slave device ICn can respectively connect to output port SDO of the previous slave device. Each slave device can include control unit 11 configured to forward the communication data packet or communication command received by the corresponding slave device, or process the communication data packet or communication command received by the corresponding slave device and forward the processed communication data packet or communication command. The processing can include modifying the relevant data in the communication data packet. In this particular example, the master device and slave device IC1-ICn can connect in series through a daisy chain.

In particular embodiments, a synchronization signal transmission method can include multiplexing the serial communication channel of the serial communication system to transmit the synchronization signal, such that the synchronization signal is transmitted to each slave device at the same time when the synchronization port of each slave device in the prior art is omitted. The synchronization signal transmission method can include controlling all slave devices to be in a through state to form a linked pathway formed by sequentially connecting a plurality of first pathways in series when a synchronization signal needs to be transmitted. That is, all slave devices can be controlled to be in a through state to form a plurality of first pathways sequentially connected when a synchronization signal needs to be transmitted, and the plurality of first pathways can sequentially connect in series to form the linked pathway. The method can also include transmitting a synchronization signal by the master device to the linked pathway, such that all slave devices receive the synchronization signal at the same time. When one of the plurality of slave device is in a through state, an input port and an output port of the corresponding slave device can be coupled together to form a first pathway, so the linked pathway may be formed by sequentially coupling a plurality of first pathways of the plurality of slave devices in series.

For example, when the synchronization signal needs to be transmitted, the master device can transmit a specific instruction indicating that the synchronization signal needs to be transmitted. Also, the current slave device may be in the first mode to receive the specific instruction transmitted by the master device or the previous slave device, and forward the specific instruction to the subsequent slave device. After that, the current slave device can be controlled to be in the second mode, the input port and output port of the current slave device can be coupled together to form a first pathway, and the current slave device may be in a through state. For example, each of the plurality of slave devices when receiving the specific instruction may serve as a current slave device. In certain embodiments, when the slave device is in the first mode, input port SDI of the slave device can be coupled to its output port SDO through control unit 11. Also, when the slave device is in the second mode, input port SDI and output port SDO of the slave device can be directly connected (e.g., shorted), in order to form a first pathway.

For example, when the synchronization signal is to be transmitted, the master device can transmit a specific instruction indicating that the synchronization signal needs to be transmitted. Slave device IC1 may receive the specific instruction transmitted by the master device, and can transmit the specific instruction to slave device IC2 through control unit 11 in the slave device IC1. Then, control unit 11 in slave device IC1 can control input port SDI and output port SDO of slave device IC1 to be connected to form a first pathway, and at this time, slave device IC1 may be in a through state.

Slave device IC2 may receive the specific instruction transmitted by slave device IC1, and can transmit the specific instruction to slave device IC3 through control unit 11 in slave device IC2. Then, control unit 11 in slave device IC2 can control input port SDI and output port SDO of slave device IC2 to be connected to form a first pathway, and at this time, slave device IC2 may be in a through state, and so on. That is, ith slave device ICi may receive the specific instruction transmitted by (i−1)^{th} slave device IC (i−1), and can transmit the specific instruction to (i+1)^{th} slave device IC (i+1) through control unit 11 in i^{th} slave device ICi. Then, control unit 11 in i^{th} slave device ICi can control input port SDI and output port SDO of i^{th} slave device ICi to connect to form a first pathway. At this time, i^{th} slave device ICi can be in a through state, where i is greater than 1 and less than n. When all slave devices are in the through state, a linked pathway may be formed from the output port of the master device to the output port of n^{th} slave device ICn.

When a linked pathway is formed, the master device can transmit a synchronization signal to the linked pathway, which can be equivalent to transmitting the synchronization signal to all slave devices in the linked pathway at the same time, such that each slave device may receive the synchronization signal at the same time. After that, control unit 11 in each slave device may receive the synchronization signal, and can perform a synchronization operation according to the synchronization signal. Further, after a predetermined time from the moment when all slave devices receive the synchronization signal, all slave devices can be controlled to be in the first mode, such that the input port of each slave device can be coupled to its output port through the control unit, where the predetermined time is greater than or equal to zero.

Each slave device can also include mode selection circuit 12. In this example, the first end of mode selection circuit 12 can connect to output port SDO of the corresponding slave device, and the second end of mode selection circuit 12 can selectively be connected to input port SDI of the corresponding slave device or the first end of control unit 11. The second end of the control unit 11 can be coupled to input port SDI of the corresponding slave device. Further, mode selection circuit 12 controlled by control unit 11 can control the corresponding slave device to operate in the first mode or the second mode. When the corresponding slave device operates in the first mode, the second end of mode selection circuit 12 can connect to the first end of control unit 11. When the corresponding slave device operates in the second mode, the second end of mode selection circuit 12 can connect to input port SDI of the corresponding slave device.

In particular embodiments, the first end of mode selection circuit 12 can be coupled to input port SDI of the corresponding slave device, and the second end of mode selection circuit 12 can selectively be coupled to output port SDO of the corresponding slave device or the first end of control unit 11. The second end of control unit 11 can be coupled to output port SDO of the corresponding slave device. When the corresponding slave device operates in the first mode, the second end of mode selection circuit 12 can connect to the first end of control unit 11. When the corresponding slave device operates in the second mode, the second end of mode selection circuit 12 can connect to output port SDO of the corresponding slave device.

In particular embodiments, mode selection circuit 12 can include selection switch S1. For example, the first end of selection switch S1 can be coupled to output port SDO of the corresponding slave device, the second end of selection switch S1 may selectively be coupled to input port SDI or the first end of control unit 11. The second end of control unit 11 can be coupled to input port SDI of the corresponding slave device. For example, after the current slave device receives the specific instruction and forwards it to the next slave device, control unit 11 of the current slave device can control selection switch S1 to switch to node a. Thus, node a can be connected to input port SDI, such that input port SDI and output port SDO of the current slave device are connected. At this time, the current slave device operates in the second mode.

When the current slave device does not receive the specific instruction, or receives the specific instruction but does not forward the specific instruction to the next slave device, control unit 11 of the current slave device can control selection switch S1 to maintain the connection with node b. Thus, node b can be coupled to the first end of control unit 11, such that input port SDI and output port SDO of the current slave device are coupled through control unit 11. At this time, the current slave device may operate in the first mode. In other examples, one end of selector switch S1 can be coupled to input port SDI, the other end of selector switch S1 may selectively be coupled to output port SDO or the first end of control unit 11, and the second end of control unit 11 can be coupled to output port SDO.

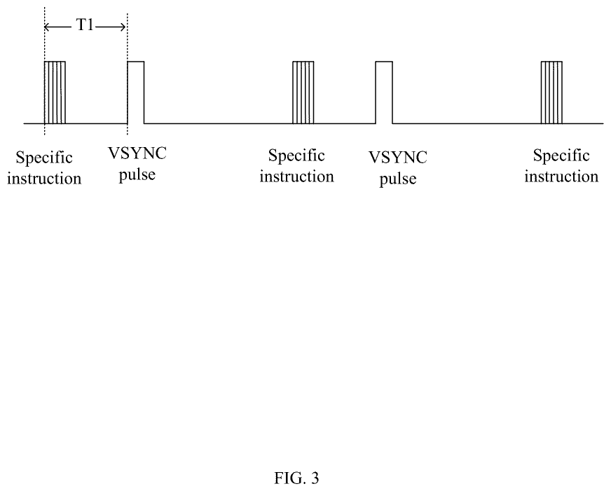

Referring now to FIG. 3, shown is a waveform diagram of an example specific instruction and an example synchronization signal, in accordance with embodiments of the present invention. In this particular example, the master device may transmit a synchronization signal VSYNC pulse after first time TI has elapsed from the moment when the master device transmits the specific instruction. For example, first time TI can be greater than or equal to the time period from the moment when the master device transmits the specific instruction to the moment when all the slave devices are in the through state. For example, when all the slave devices are in the through state, the master device can immediately transmit a synchronization signal to the linked pathway. In another example, the master device may transmit a synchronization signal to the linked pathway after a period of time has elapsed form the moment when all the slave devices are in the through state.

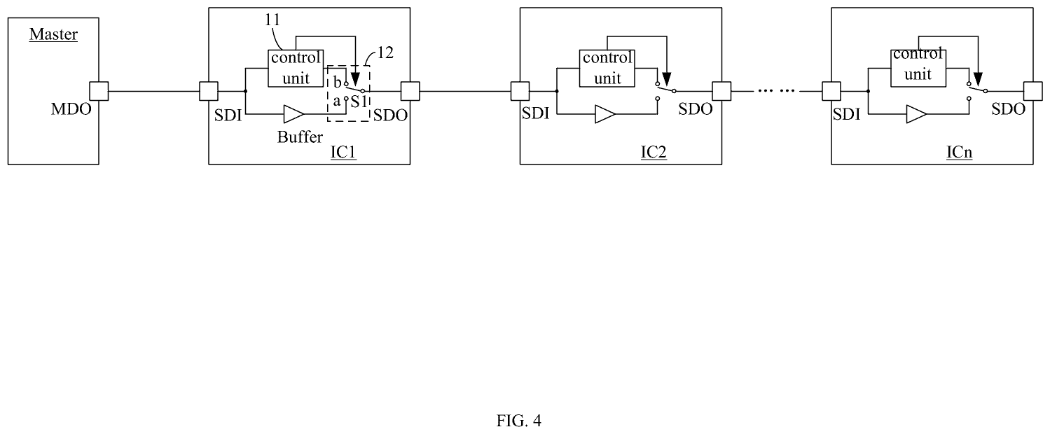

Referring now to FIG. 4, shown is a schematic diagram of a second example serial communication system, in accordance with embodiments of the present invention. In this particular example, when the corresponding slave device operates in the second mode, the input port SDI of the corresponding slave device can connect to its output SDO port through a buffer, in order to enhance the driving ability. In the second mode, input port SDI of the corresponding slave device can connect to its output port SDO through other devices, so long as the input port SDI and output port SDO of the corresponding slave device are coupled to form the first pathway in the second mode.

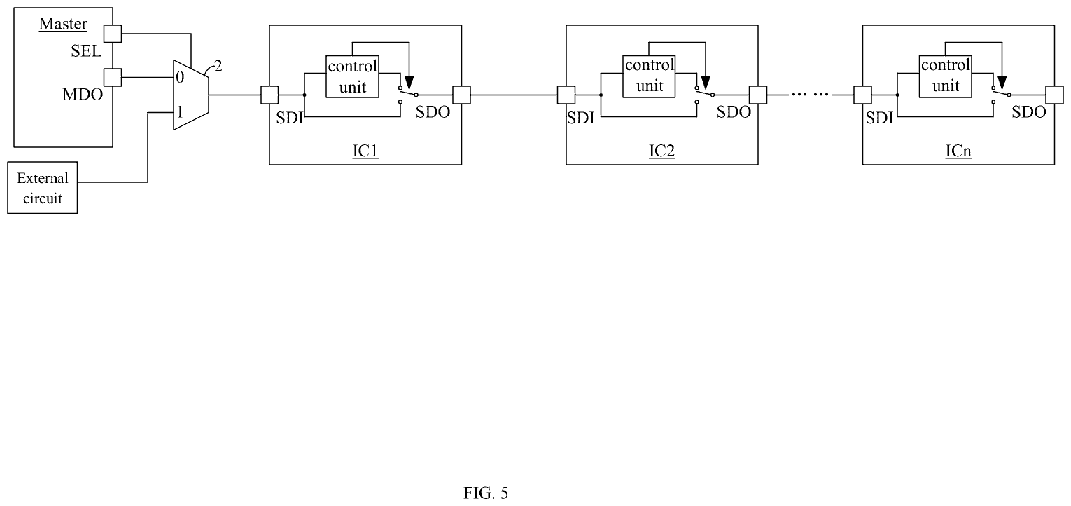

Referring now to FIG. 5, shown is a schematic diagram of a third example serial communication system, in accordance with embodiments of the present invention. In this particular example, the synchronization signal may not be transmitted by the master device, but instead by an external circuit (e.g., a circuit other than the serial communication system). For example, multiplexer 2 can be coupled between the master device and slave device IC1. The first input end of multiplexer 2 can be coupled to output port MDO of the master device, the second input end of multiplexer 2 may be coupled to the output terminal of an external circuit, the output end of multiplexer 2 can be coupled to input port SDI of slave device IC1, and the control end of multiplexer 2 may be coupled to the SEL port of the master device. In this example, when the SEL port outputs a low-level signal (e.g., 0), multiplexer 2 can transfer the signal output by the master device to input port SDI of slave device IC1. When the SEL port outputs a high-level signal (e.g., 1), multiplexer 2 can transfer the signal output by the external circuit to input port SDI of slave device IC1. In this example, after the master device transmits a specific instruction, the signal output from the SEL port can transition from low level to high level, such that slave device IC1 receives the synchronization signal transmitted by the external circuit.

When the serial communication system in particular embodiments is applied to the backlight system, each slave device can drive at least one light-emitting diode (LED) string, and the synchronization signal may have different functions. In one example, the synchronization signal can be used as a reference moment when the brightness of an LED string needs to be changed, or when the LED brightness signal starts to take effect. For example, when the brightness of one LED string needs to be changed, the LED brightness signal can accordingly change, and the slave device corresponding to the LED string can change the brightness of the LED string after delaying for a second time interval from the rising edge or falling edge of the pulse of the synchronization signal.

In another example, the synchronization signal can be phase-locked and frequency-doubled to generate an LED current control signal synchronized with the synchronization signal to drive the LED string. For example, the slave device can generate the frequency of the LED current control signal for driving the LED string according to the frequency of the synchronization signal, in order to improve the accuracy of the LED current in one period of the synchronization signal. For example, the frequency of the LED current control signal can be equal to the product of a first coefficient and the frequency of the synchronization signal, and the first coefficient may be a positive integer.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A method of synchronization signal transmission for a serial communication system having a master device and a plurality of slave devices coupled in series, the method comprising:
a) controlling the plurality of slave devices to be in a through state, in order to form a linked pathway when a synchronization signal needs to be transmitted; and
b) transmitting the synchronization signal to the linked pathway, such that the plurality of slave devices receive the synchronization signal at the same time.

2. The method of claim 1, wherein:
a) when one of the plurality of slave device is in a through state, coupling an input port and an output port of the corresponding slave device together to form a first pathway; and
b) the linked pathway is formed by coupling the first pathways of the plurality of slave devices in series.

3. The method of claim 1, wherein:
a) the master device transmits a specific instruction indicating that a synchronization signal needs to be transmitted;
b) each of the plurality of slave devices when receiving the specific instruction serves as a current slave device;
c) the current slave device is controlled to be in a first mode to receive the specific instruction from the master device or a previous slave device, and to forward the specific instruction to a subsequent slave device; and
d) the current slave device is controlled to be in a second mode, an input port and an output port of the current slave device are coupled to form a first pathway, and the current slave device is in a through state.

4. The method of claim 2, wherein the coupling the input port and the output port of the slave device comprises connecting the input port and the output port of the slave device directly, or connecting the input port and the output port of the slave device through a buffer.

5. The method of claim 1, wherein each of the plurality of slave devices comprises a control unit, wherein:
a) when one of the plurality of slave devices is in a first mode, an input port and an output port of the corresponding slave device are connected through the control unit; and
b) when one of the plurality of slave devices is in a second mode, the input port and output port of the corresponding slave device are connected directly, or the input port and the output port of the corresponding slave device are connected through a buffer to form a first pathway.

6. The method of claim 1, wherein a control unit in each of the plurality of slave device receives the synchronization signal and performs synchronization operation according to the synchronization signal.

7. The method of claim 1, wherein the synchronization signal is transmitted by the master device or by an external circuit.

8. The method of claim 1, wherein after a predetermined time has elapsed from a moment when the plurality of slave devices receive the synchronization signal, the plurality of slave devices are controlled to be in a first mode, such that an input port and an output port of each of the plurality of slave devices are connected through a control unit, wherein the predetermined time is greater than or equal to zero.

9. The method of claim 1, wherein the transmitting the synchronization signal occurs after a first time has elapsed from a moment when the master device transmits a specific instruction indicating that the synchronization signal needs to be transmitted, wherein the first time is greater than or equal to a time period from a moment when the master device transmits the specific instruction to a moment when the plurality of slave devices are in the through state.

10. The method of claim 5, wherein each of the plurality of slave devices further comprises:
a) a mode selection circuit, having a first end coupled to the input port of the corresponding slave device, and a second end selectively coupled to the output port of the corresponding slave device or a first end of a control unit, wherein a second end of the control unit is coupled to the output port of the corresponding slave device; and
b) wherein the mode selection circuit controlled by the control unit is configured to control the corresponding slave device to operate in one of the first mode and the second mode.

11. The method of claim 10, wherein the mode selection circuit comprises a selection switch.

12. The method of claim 10, wherein in the second mode, the second end of the mode selection circuit is connected to the output port of the corresponding slave device, or is coupled to the output port of the corresponding slave device through a buffer.

13. The method of claim 10, wherein in the first mode, the second end of the mode selection circuit is connected to the first end of the control unit.

14. The method of claim 5, wherein each of the plurality of slave devices further comprises:
a) a mode selection circuit, having a first end coupled to the output port of the corresponding slave device, and a second end selectively coupled to the input port of the corresponding slave device or a first end of a control unit, wherein a second end of the control unit is coupled to the input port of the corresponding slave device; and
b) wherein the mode selection circuit controlled by the control unit is configured to control the corresponding slave device to operate in one of the first mode and the second mode.

15. The method of claim 14, wherein in the second mode, the second end of the mode selection circuit is connected to the input port of the corresponding slave device, or is coupled to the input port of the corresponding slave device through a buffer.

16. The method of claim 14, wherein in the first mode, the second end of the mode selection circuit is connected to the first end of the control unit.

17. The method of claim 14, wherein the mode selection circuit comprises a selection switch.

18. The method of claim 1, wherein:
a) each slave device is configured for driving at least one light-emitting diode (LED) string;
b) when a brightness of one LED string needs to be changed, the slave device corresponding to the LED string changes the brightness of the LED string after delaying for a second time from a rising edge or a falling edge of a pulse of the synchronization signal; and
c) the second time is greater than or equal to zero.

19. The method of claim 1, wherein:
a) each slave device is configured for driving at least one LED string;
b) the slave device is configured to generate a frequency of an LED current control signal for driving an LED string according to a frequency of the synchronization signal, in order to improve accuracy of an LED current in one period of the synchronization signal; and
c) the frequency of the LED current control signal is equal to a product of a first coefficient and the frequency of the synchronization signal, and the first coefficient is a positive integer.

20. A serial communication system, comprising the method of claim 1, wherein:
a) the master device and the plurality of slave devices are coupled in series in sequence; and
b) the plurality of slave devices receive the synchronization signal at the same time.
